(19) United States
(12) Patent Application Publication
(10) Pub. No.: US 2021/0114590 A1
(43) Pub. Date: Apr. 22, 2021

(54) COLLISION DETERMINATION DEVICE

(71) Applicant: DENSO CORPORATION, Kariya-city (JP)

(72) Inventor: Shogo MATSUNAGA, Kariya-city (JP)

(21) Appl. No.: 17/138,060

(22) Filed: Dec. 30, 2020

Related U.S. Application Data
(63) Continuation of application No. PCT/JP2019/022512, filed on Jun. 6, 2019.

(30) Foreign Application Priority Data
Jul. 2, 2018 (JP) 2018-126342

(51) Int. Cl. B60W 30/09; B60W 30/095; B60W 10/20; G05D 1/02

(52) U.S. Cl. CPC B60W 30/09; B60W 30/0956; B60W 10/18; B60W 10/20; G05D 1/0214; B60W 30/0953

(57) ABSTRACT

A collision determination device includes: an own vehicle region calculation unit that calculates an own vehicle presence region for each predetermined time on an estimated route of the own vehicle in a two-dimensional coordinate system defined by a distance in an own vehicle traveling direction and a distance in a vehicle width direction of the own vehicle at a current time;

an own vehicle information calculation unit that calculates an own vehicle solid by interpolating the calculated own vehicle presence region for each predetermined time in a three-dimensional coordinate system defined by the distance in the own vehicle traveling direction, the distance in the vehicle width direction, and elapsed time from the current time, the own vehicle solid being a solid showing change of the own vehicle presence region; a movement path calculation unit that calculates a movement path of the object in the three-dimensional coordinate system on the basis of a position of the object detected by the object detection device; and a determination unit that determines whether the object will collide with the own vehicle on the basis of whether the calculated own vehicle solid intersects the calculated movement path of the object.

### CROSS-REFERENCE TO RELATED APPLICATION

This application is the U.S. bypass application of International Application No. PCT/JP2019/022512 filed on Jun. 6, 2019 which designated the U.S. and claims priority to Japanese Patent Application No. 2018-126342 filed on Jul. 2, 2018, the contents of both of which are incorporated herein by reference.

### TECHNICAL FIELD

The present disclosure relates to a collision determination device that determines whether the own vehicle will collide with an object around the own vehicle.

### BACKGROUND

A collision determination device is known that estimates a movement locus of the own vehicle and a movement locus of an object around the own vehicle and determines whether the object will collide with the own vehicle on the basis of the estimated movement loci of the own vehicle and the object. A collision determination device disclosed in JP 2008-213535 A calculates an intersection point at which an estimated movement locus of the own vehicle intersects an estimated movement locus of an object. Then, the collision determination device calculates time required for the own vehicle to reach the intersection point and time required for the object to reach the intersection point, and determines whether the object will collide with the own vehicle on the basis of the calculated time.

### SUMMARY

According to an aspect of the present disclosure, the present disclosure relates to a collision determination device that determines whether the own vehicle will collide with an object that is located around the own vehicle and detected by an object detection device. The collision determination device includes: an own vehicle region calculation unit that calculates an own vehicle presence region for each predetermined time on an estimated route of the own vehicle in a two-dimensional coordinate system defined by a distance in an own vehicle traveling direction and a distance in a vehicle width direction of the own vehicle at a current time; an own vehicle information calculation unit that calculates an own vehicle solid by interpolating the calculated own vehicle presence region for each predetermined time in a three-dimensional coordinate system defined by the distance in the own vehicle traveling direction, the distance in the vehicle width direction, and elapsed time from the current time, the own vehicle solid being a solid showing change of the own vehicle presence region; a movement path calculation unit that calculates estimated route information indicating an estimated value of a movement path of the object in the three-dimensional coordinate system on the basis of a position of the object detected by the object detection device; and a determination unit that determines whether the object will collide with the own vehicle on the basis of whether the calculated own vehicle solid intersects the calculated movement path of the object.

### BRIEF DESCRIPTION OF THE DRAWINGS

The above features of the present disclosure will be made clearer by the following detailed description, given referring to the appended drawings. In the accompanying drawings:

FIG. 1 is a configuration diagram of a vehicle control system;

FIGS. 2A and 2B are diagrams each illustrating an own vehicle presence region in an XY plane;

FIGS. 3A and 3B are diagrams each illustrating an object presence region in the XY plane;

FIG. 4 is a diagram illustrating an own vehicle solid and an object solid;

FIGS. 5A and 5B are diagrams each illustrating a method for collision determination of whether an object will collide with the own vehicle using the own vehicle solid and the object solid;

FIG. 6 is a flow chart illustrating a procedure of the collision determination;

FIGS. 7A and 7B are diagrams each illustrating an increase in the own vehicle presence region when the own vehicle turns right or left;

FIGS. 8A and 8B are diagrams each illustrating an increase amount of the own vehicle presence region in a modification of the first embodiment;

FIG. 9 is a flow chart illustrating a procedure of the collision determination according to a second embodiment;

FIG. 10 is a flow chart illustrating a procedure of the process at step S18 in FIG. 6 according to a third embodiment;

FIG. 11 is a diagram illustrating an increase amount of the object presence region; and

FIG. 12 is a flow chart illustrating a procedure of the collision determination according to a fourth embodiment.

### DETAILED DESCRIPTION OF THE PREFERRED EMBODIMENTS

When the movement locus of the own vehicle and the movement locus of the object are each estimated as a line and an intersection point of the lines are used to perform collision determination, in some cases, the collision determination cannot be appropriately performed depending on a positional relationship between the own vehicle and the object or a movement state of the object.

The present disclosure has been made in view of the above problem, and has an object of providing a collision determination device capable of appropriately performing collision determination of whether an object will collide with the own vehicle in consideration of the elapse of time, regardless of a positional relationship of the object with respect to the own vehicle or a movement state of the object.

According to an aspect of the present disclosure, the present disclosure relates to a collision determination device that determines whether the own vehicle will collide with an object that is located around the own vehicle and detected by an object detection device. The collision determination device includes: an own vehicle region calculation unit that calculates an own vehicle presence region for each predetermined time on an estimated route of the own vehicle in a two-dimensional coordinate system defined by a distance in an own vehicle traveling direction and a distance in a vehicle width direction of the own vehicle at a current time; an own vehicle information calculation unit that calculates an own vehicle solid by interpolating the calculated own vehicle presence region for each predetermined time in a three-dimensional coordinate system defined by the distance in the own vehicle traveling direction, the distance in the vehicle width direction, and elapsed time from the current time, the own vehicle solid being a solid showing change of the own vehicle presence region; a movement path calculation unit that calculates estimated route information indicating an estimated value of a movement path of the object in the three-dimensional coordinate system on the basis of a position of the object detected by the object detection device; and a determination unit that determines whether the object will collide with the own vehicle on the basis of whether the calculated own vehicle solid intersects the calculated movement path of the object.

In the above configuration, the own vehicle solid which is a solid showing change of the own vehicle presence region is calculated by interpolating a plurality of own vehicle presence regions calculated on the estimated route of the own vehicle in the three-dimensional coordinate system defined by the distance in the own vehicle traveling direction and the distance in the vehicle width direction relative to the own vehicle, and the elapsed time from the current time. Furthermore, the estimated route information indicating the estimated value of the movement path of the object is calculated in the three-dimensional coordinate system on the basis of the position of the object detected by the object detection device. Then, it is determined whether the object will collide with the own vehicle on the basis of whether the own vehicle solid intersects the movement path of the object. In this case, the own vehicle solid used for the collision determination of whether the object will collide with the own vehicle is calculated as a three-dimensional solid in which the own vehicle presence region that spreads across the own vehicle traveling direction and the vehicle width direction continues along the time axis. Then, the collision determination is performed on the basis of whether the own vehicle solid intersects the movement path of the object. Thus, the intersection occurs in a larger region than in the case where a movement locus of the own vehicle intersects a movement locus of the object. This allows collision determination corresponding to various situations with various positional relationships of the object with respect to the own vehicle and movement states of the object, leading to appropriate determination of whether the object will collide with the own vehicle. Furthermore, it is determined whether a collision occurs on the basis of whether the own vehicle solid intersects the movement path of the object in the three-dimensional coordinate system. Thus, the determination of whether a collision occurs can be appropriately performed in consideration of the elapse of time.

### First Embodiment

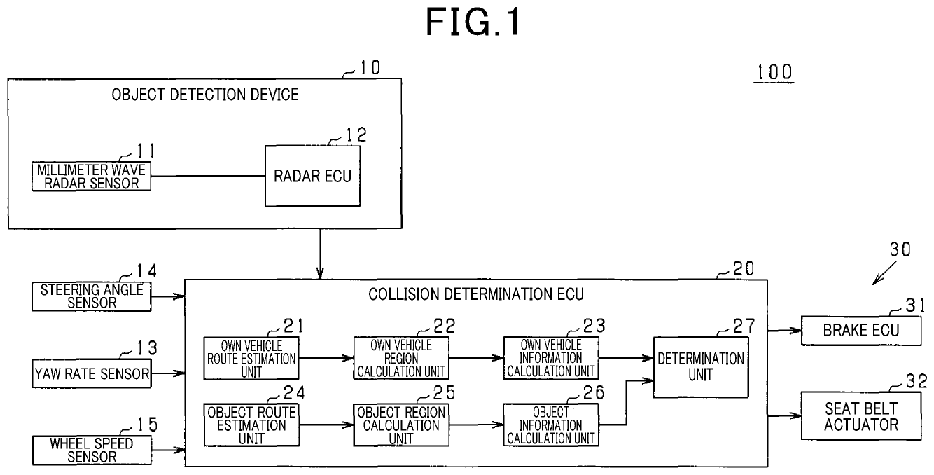

An embodiment of a vehicle control system that is applied to a vehicle will be described below with reference to the drawings. A vehicle control system 100 shown in FIG. 1 includes an object detection device 10 and a collision determination ECU 20. In the present embodiment, the collision determination ECU 20 corresponds to a collision determination device.

The object detection device 10 transmits millimeter waves, and detects a position of an object around the own vehicle and a relative speed of the object to the own vehicle on the basis of a reflected wave generated by reflection of the transmitted millimeter waves from the object. The object detection device 10 includes a millimeter wave radar sensor 11 and a radar ECU 12.

The millimeter wave radar sensor 11 is mounted on, for example, each of the front and rear of the own vehicle, and emits millimeter waves to the surroundings of the own vehicle and receives a reflected wave of the millimeter wave. The millimeter wave radar sensor 11 outputs, to the radar ECU 12, a reflected wave signal related to the received reflected wave.

The radar ECU 12 calculates a position of an object around the own vehicle and a relative speed of the object to the own vehicle on the basis of the reflected wave signal outputted from the millimeter wave radar sensor 11. The radar ECU 12 outputs, to the collision determination ECU 20, the position of the object and the relative speed of the object to the own vehicle thus calculated. The radar ECU 12 is composed of, for example, a computer including a CPU (Central Processing Unit), a ROM (Read Only Memory), a RAM (Random Access Memory), an input-output interface, and the like.

The collision determination ECU 20 is connected to a yaw rate sensor 13, a steering angle sensor 14, a wheel speed sensor 15, and a collision prevention device 30. The yaw rate sensor 13 is provided, for example, at the center position of the own vehicle, and outputs, to the collision determination ECU 20, a yaw rate signal corresponding to a change rate of a steering amount of the own vehicle. The steering angle sensor 14 is mounted on, for example, a steering rod of the vehicle, and outputs, to the collision determination ECU 20, a steering angle signal corresponding to a change in steering angle of a steering wheel due to an operation by the driver. The wheel speed sensor 15 is mounted on, for example, a wheel portion of the vehicle, and outputs, to the collision determination ECU 20, a wheel speed signal corresponding to a wheel speed of the vehicle.

The collision prevention device 30 is a device that prevents a collision of an object with the own vehicle. In the present embodiment, the collision prevention device 30 includes a brake ECU 31 and a seat belt actuator 32.

The brake ECU 31 controls a braking force of a brake actuator on the basis of a deceleration signal outputted from the collision determination ECU 20. The braking force of the brake actuator is controlled to adjust a deceleration amount of the own vehicle. The seat belt actuator 32 operates a seat belt winding device on the basis of a start signal outputted from the collision determination ECU 20, and winds in and tightens the seat belt.

The collision determination ECU 20 determines whether the object will collide with the own vehicle on the basis of the position of the object and the relative speed of the object to the own vehicle outputted from the object detection device 10. The collision determination ECU 20 is composed of a computer including a CPU, a ROM, a RAM, an input-output interface, and the like. When the collision determination ECU 20 determines that the object will collide with the own vehicle, the collision determination ECU 20 operates the collision prevention device 30 to perform collision prevention control for the own vehicle. For example, the collision determination ECU 20 performs collision prevention control by generating a deceleration signal to be outputted to the brake ECU 31 and a start signal to be outputted to the seat belt actuator 32 and outputting the signals.

If linear movement loci are calculated as movement paths of the own vehicle and the object and an intersection point of the calculated movement loci is used to determine whether the object will collide with the own vehicle, depending on a positional relationship between the own vehicle and the object or a movement state of the object, in some cases, the collision determination of whether the object will collide with the own vehicle cannot be appropriately performed. For example, when the own vehicle and the object are moving in parallel, the movement locus of the own vehicle does not intersect the movement locus of the object; thus, the object collision determination cannot be performed. Furthermore, when the object is stationary, the movement locus of the object is not calculated even in consideration of the elapse of time. Thus, an intersection point of the movement locus of the own vehicle and the movement locus of object is not calculated, and this may hinder the collision determination of whether the object will collide with the own vehicle.

Thus, the collision determination ECU 20 calculates an own vehicle solid in a three-dimensional coordinate system that is virtually formed. The own vehicle solid is a solid showing change of an own vehicle presence region. Furthermore, the collision determination ECU 20 calculates a movement path of the object in the three-dimensional coordinate system. Then, the collision determination ECU 20 determines whether the own vehicle will collide with the object on the basis of whether the own vehicle solid intersects the movement path of the object. This allows collision determination corresponding to various situations with various positional relationships of the object with respect to the own vehicle and movement states of the object.

Next, functions of the collision determination ECU 20 related to the collision determination of the present embodiment will be described.

An own vehicle route estimation unit 21 calculates an own vehicle estimated route PA1 on the basis of a change rate of the steering amount of the own vehicle and an own vehicle speed. The own vehicle estimated route PA1 indicates an estimated route of the own vehicle. In the present embodiment, the own vehicle route estimation unit 21 calculates an estimated curve radius for the own vehicle on the basis of a yaw rate ψ of the own vehicle calculated by using a yaw rate signal from the yaw rate sensor 13 and an own vehicle speed calculated by using a wheel speed signal from the wheel speed sensor 15. Then, the own vehicle route estimation unit 21 calculates, as the own vehicle estimated route PA1, a route of the own vehicle when the own vehicle travels according to the calculated estimated curve radius. The change rate of the steering amount of the own vehicle may be calculated on the basis of a steering angle signal from the steering angle sensor 14.

An own vehicle region calculation unit 22 calculates an own vehicle presence region EA1 in an XY plane of a two-dimensional coordinate system defined by a distance Y in an own vehicle traveling direction and a distance X in a vehicle width direction at a current time. The own vehicle presence region EA1 indicates a region on the own vehicle estimated route PA1 in which the own vehicle is present for each predetermined time. In the present embodiment, the own vehicle region calculation unit 22 calculates the own vehicle presence region EA1 at positions on the own vehicle estimated route PA1 during a period from a current time T0 to an estimated end time TN.

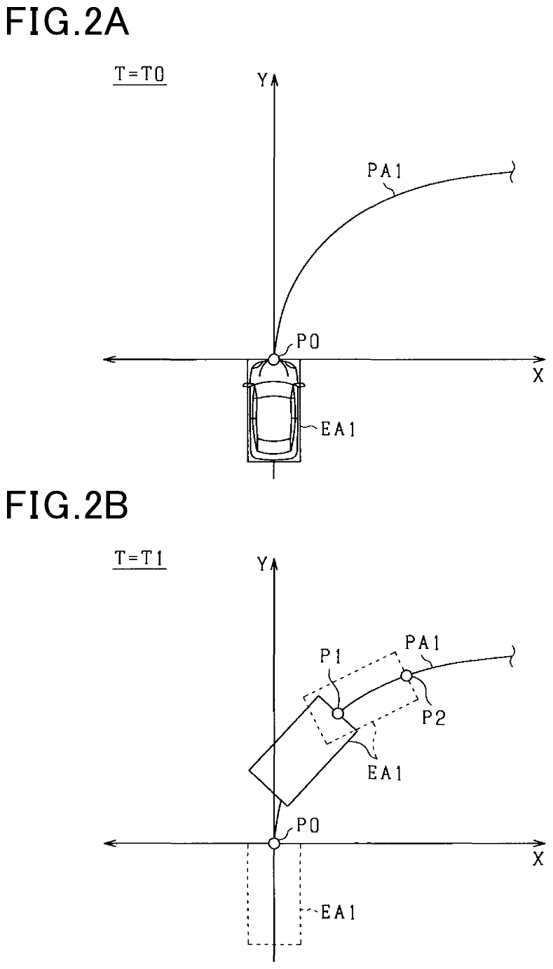

FIG. 2A shows the own vehicle presence region EA1 at the current time T0. In the present embodiment, the own vehicle presence region EA1 is determined as a rectangular region including the entire outer periphery of the own vehicle as viewed from above the own vehicle. The own vehicle region calculation unit 22 determines the rectangular region that forms the own vehicle presence region EA1 on the basis of vehicle specifications indicating the size of the own vehicle. For example, the own vehicle presence region EA1 at the current time T0 is determined so that a reference position P0 of the own vehicle is located at the intersection point (0, 0) of an X-axis and a Y-axis. The reference position P0 of the own vehicle is set to be located at the center in the vehicle width direction in front of the own vehicle.

FIG. 2B shows the own vehicle presence region EA1 after a time T1 from the current time. In FIG. 2B, in order to facilitate the description, the own vehicle presence region EA1 at the current time T0 and the own vehicle presence region EA1 after a time T2 (T2>T1) from the current time are indicated by a dashed line.

The own vehicle presence region EA1 after T1 from the current time indicates an own vehicle presence region after the elapsed time T1 from the current position of the own vehicle when the own vehicle moves along the own vehicle estimated route PA1. For example, on the basis of the own vehicle estimated route PA1 and the own vehicle speed calculated at the current position of the own vehicle, the own vehicle region calculation unit 22 calculates a passing position on the own vehicle estimated route PA1 after a predetermined elapsed time Tn (n is a value of 0 or more and N or less) from the reference position P0 of the own vehicle at the current time T0. Then, the own vehicle region calculation unit 22 calculates, as the own vehicle presence region EA1 after Tn from the current time, a rectangular region in which a reference position Pn is located at each passing position. In the present embodiment, a direction of the own vehicle presence region EA1 at each elapsed time Tn is determined as a tangential direction of the own vehicle estimated route PA1 at the corresponding reference position Pn.

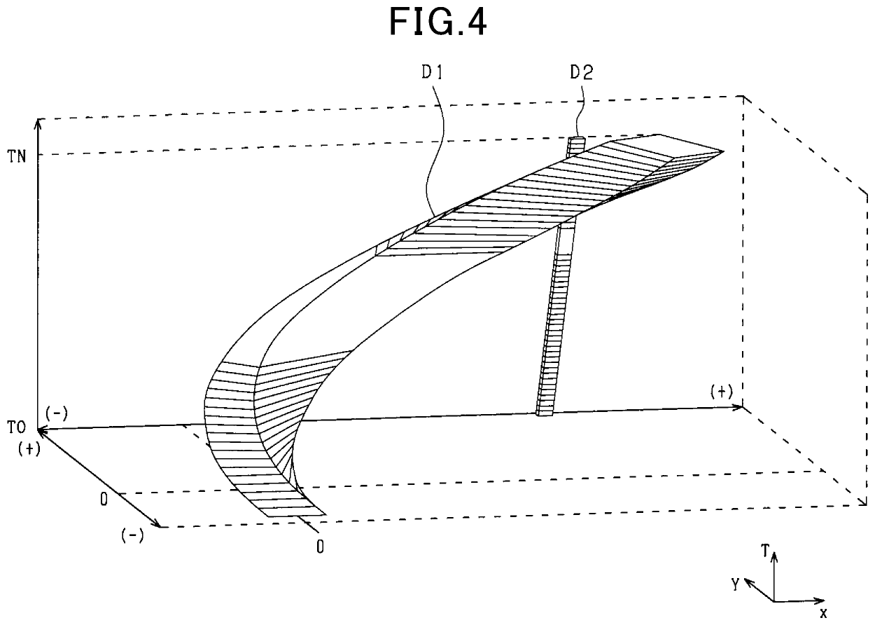

An own vehicle information calculation unit 23 calculates an own vehicle solid D1 by interpolating a plurality of own vehicle presence regions EA1 in a three-dimensional coordinate system defined by the distance Y in the own vehicle traveling direction, the distance X in the vehicle width direction, and elapsed time T from the current time. The own vehicle solid D1 shows change of the own vehicle presence region EA1. In a three-dimensional coordinate system shown in FIG. 4, the point (0, 0, 0) indicates the reference position P0 of the own vehicle at the current time. The own vehicle solid D1 shows movement change of the own vehicle presence region EA1 with the elapsed time T in the three-dimensional coordinate system. In FIG. 4, the own vehicle solid D1 is calculated for a predicted duration from the current time T0 to the estimated end time TN.

In the present embodiment, the own vehicle information calculation unit 23 converts the calculated plurality of own vehicle presence regions EA1 into information in the three-dimensional coordinate system. Then, the own vehicle information calculation unit 23 calculates the own vehicle solid D1 by linearly interpolating, in the three-dimensional coordinate system, four corners of the own vehicle presence regions EA1 adjacent to each other in the direction in which a T-axis defining the elapsed time extends.

An object route estimation unit 24 calculates an object estimated route PA2 on the basis of the position of the object and the relative speed of the object to the own vehicle detected by the object detection device 10. The object estimated route PA2 indicates an estimated route of the object. For example, the object route estimation unit 24 calculates a movement locus of the object on the basis of a change in the position of the object detected by the object detection device 10, and determines the movement locus as the object estimated route PA2.

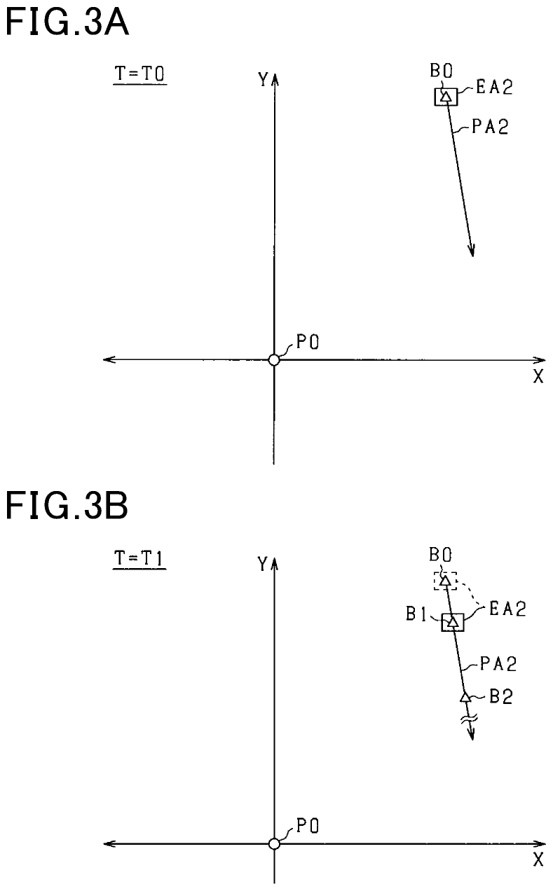

An object region calculation unit 25 calculates an object presence region EA2 in the XY plane. The object presence region EA2 indicates a region on the object estimated route PA2 in which the object is present for each predetermined time. The object presence region EA2 indicates an object presence region for each predetermined time when the object moves along the object estimated route PA2. FIG. 3A shows the object presence region EA2 at the current time T0. The object presence region EA2 in the XY plane at the current time T0 indicates an object presence region of the object detected by the object detection device 10 at the current position of the own vehicle. The object region calculation unit 25 sets the object presence region EA2 as a rectangular region including the entire outer periphery of the object as viewed from above the object. For example, the rectangular region that forms the object presence region EA2 is set on the basis of the size of the object calculated by the object detection device 10.

FIG. 3B shows the object presence region EA2 after T1 from the current time. For example, on the basis of the object estimated route PA2 and the relative speed of the object with respect to the own vehicle, the object region calculation unit 25 calculates a passing position on the object estimated route PA2 after a predetermined elapsed time Tn from a reference position B0 of the object at the current time. Then, the object region calculation unit 25 calculates, as the object presence region EA2 after the elapsed time Tn from the current time, a rectangular region in which a reference position Bn is located at each passing position.

An object information calculation unit 26 calculates an object solid D2 by interpolating a plurality of object presence regions EA2 in the three-dimensional coordinate system. The object solid D2 is a solid showing change of the object presence region EA2. The object solid D2 in FIG. 4 shows movement change of the object presence region EA2 with the elapsed time T in the three-dimensional coordinate system. In the present embodiment, the object information calculation unit 26 calculates the object solid D2 by linearly interpolating four corners of the object presence regions EA2 adjacent to each other in the direction in which the T-axis defining the elapsed time extends. In the present embodiment, the object solid D2 corresponds to the movement path of the object, and the object region calculation unit 25 and the object information calculation unit 26 correspond to a movement path calculation unit.

A determination unit 27 determines whether the object will collide with the own vehicle on the basis of whether the own vehicle solid D1 intersects the object solid D2. In the present embodiment, the determination unit 27 uses the own vehicle solid D1 to calculate a first determination region DA1 that indicates the own vehicle presence region at the predetermined elapsed time T. Furthermore, the determination unit 27 uses the object solid D2 to calculate a second determination region DA2 that indicates the object presence region at the same predetermined elapsed time T as that for the first determination region DA1. Then, when an overlapping region is present between the first determination region DA1 and the second determination region DA2 at the same elapsed time T thus calculated, the determination unit 27 determines that the own vehicle solid D1 intersects the object solid D2.

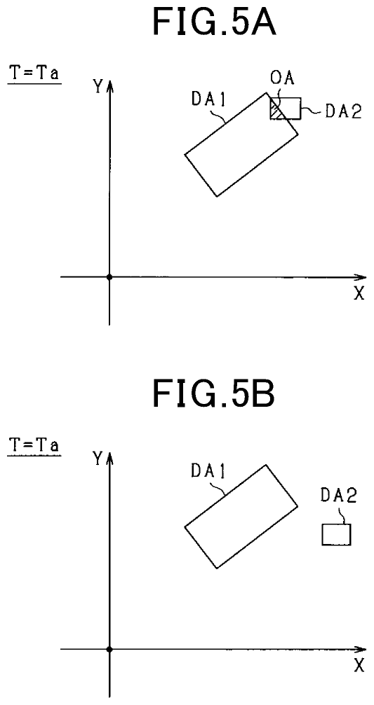

FIGS. 5A and 5B are diagrams showing the first determination region DA1 calculated by using the own vehicle solid D1 and the second determination region DA2 calculated by using the object solid D2 in the XY plane at elapsed time Ta. When the own vehicle solid D1 intersects the object solid D2, as shown in FIG. 5A, an overlapping region OA is present between the first determination region DA1 and the second determination region DA2 in the XY plane at the same elapsed time Ta. Thus, when the overlapping region OA is present between the first determination region DA1 and the second determination region DA2 at the same elapsed time T, the determination unit 27 determines that the own vehicle will collide with the object.

On the other hand, when the own vehicle solid D1 does not intersect the object solid D2, the overlapping region OA is not present between the first determination region DA1 and the second determination region DA2 in the XY plane at any elapsed time T including the elapsed time Ta shown in FIG. 5B. Thus, when the overlapping region OA is not present between the first determination region DA1 and the second determination region DA2 at the same elapsed time T, the determination unit 27 determines that the own vehicle does not collide with the object.

In the present embodiment, the determination unit 27 calculates the first determination region DA1 and the second determination region DA2 at the same elapsed time T for each predetermined elapsed time interval ΔT during a period from the current time T0 to the estimated end time TN. Then, the determination unit 27 determines whether the overlapping region OA is present by using the first determination region DA1 and the second determination region DA2 at the same elapsed time T thus calculated.

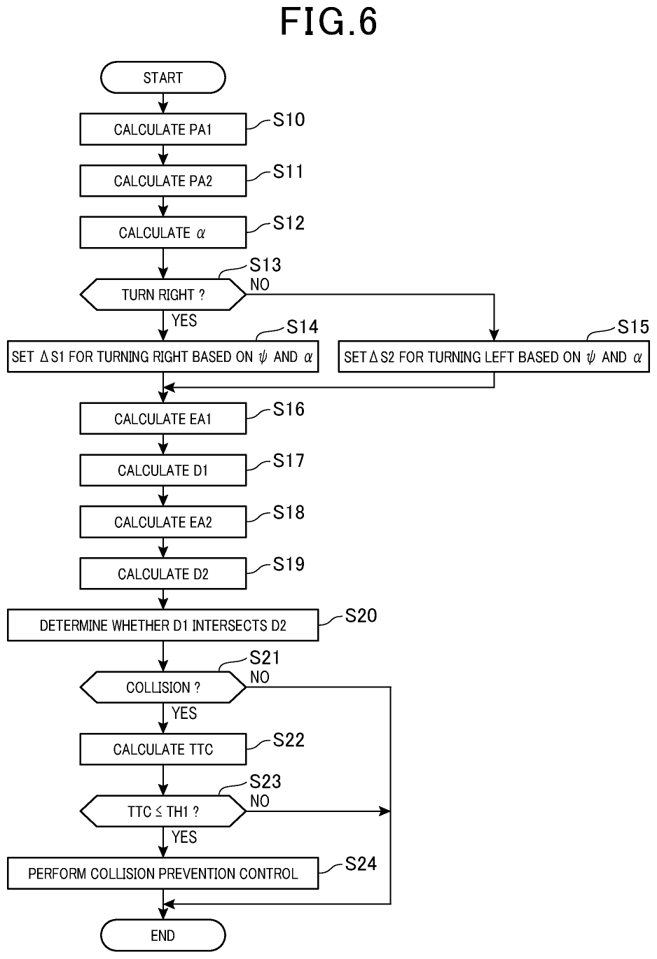

Next, a procedure of the collision determination according to the present embodiment will be described with reference to FIG. 6. A process shown in FIG. 6 is repeatedly performed in a predetermined cycle by the collision determination ECU 20.

At step S10, the own vehicle estimated route PA1 at the current position of the own vehicle is calculated in the XY plane on the basis of the own vehicle speed calculated from the wheel speed signal and the yaw rate ψ of the own vehicle calculated from the yaw rate signal.

At step S11, the object estimated route PA2 is calculated in the XY plane on the basis of the position of the object and the relative speed of the object to the own vehicle detected by the object detection device 10.

At steps S12 to S16, a plurality of own vehicle presence regions EA1 on the own vehicle estimated route PA1 are calculated. When an error occurs in the own vehicle estimated route PA1, as the position of the own vehicle presence region EA1 is located farther from the current position toward a future position on the own vehicle estimated route PA1, the error in the own vehicle estimated route PA1 is accumulated at the position of the own vehicle presence region EA1, resulting in an increase in the error in the position of the own vehicle presence region EA1. Thus, in the present embodiment, the own vehicle presence region EA1 is calculated so that an area S of the own vehicle presence region EA1 is increased as the own vehicle presence region EA1 is located farther from the current position toward a future position on the own vehicle estimated route PA1.

First, at step S12, a change acceleration α of the steering amount of the own vehicle is calculated on the basis of the yaw rate ψ that indicates the change rate of the steering amount of the own vehicle. In the present embodiment, a difference between the yaw rate ψ calculated in the previous calculation cycle and the yaw rate ψ calculated in the current calculation cycle is calculated as the change acceleration α of the steering amount. Step S12 corresponds to a steering change amount calculation unit. The change acceleration α of the steering amount of the own vehicle may be calculated from a change rate of the steering angle calculated by using a steering angle signal from the steering angle sensor 14.

At step S13, it is determined whether the own vehicle turns right or left. In the present embodiment, when the calculated estimated curve radius is a radius of a curve to the right with respect to the own vehicle traveling direction at the current time, it is determined that the own vehicle turns right. When the calculated estimated curve radius is a radius of a curve to the left with respect to the own vehicle traveling direction at the current time, it is determined that the own vehicle turns left.

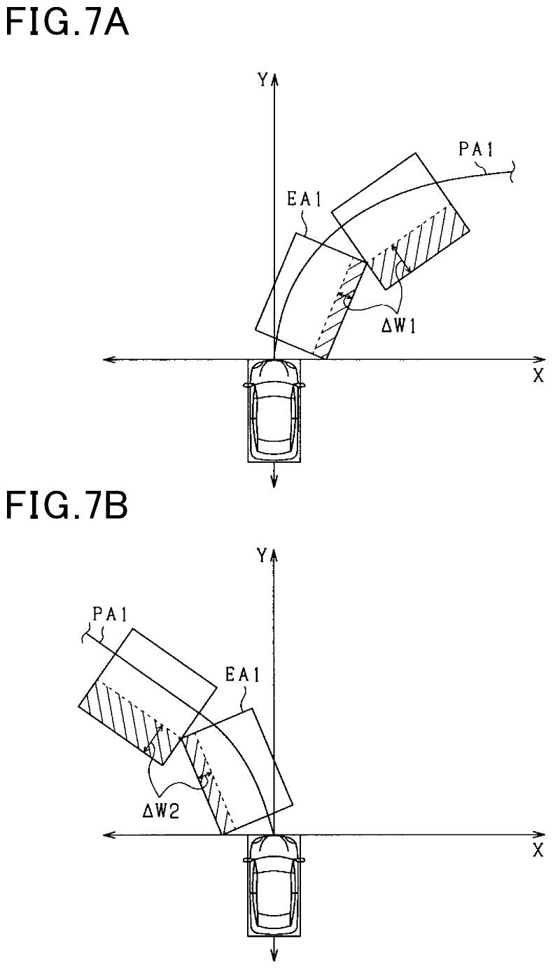

In a case where it is determined at step S13 that the own vehicle turns right, at step S14, an increase amount ΔS1 of the own vehicle presence region EA1 when the own vehicle turns right is set on the basis of the yaw rate ψ and the change acceleration α of the steering amount of the own vehicle. In FIG. 7A, a hatched area indicates the increase amount ΔS1 of the own vehicle presence region EA1 when the own vehicle turns right. In FIGS. 7A and 7B, in order to facilitate the description, a plurality of own vehicle presence regions EA1 at different elapsed times T are shown in the same XY plane.

As the change in the steering amount of the own vehicle is increased, the position of the own vehicle is more likely to be changed in the vehicle width direction. Furthermore, when the own vehicle turns right, due to the change in the position of the own vehicle in the vehicle width direction, an object that passes on the right side of the own vehicle is more likely to collide with the own vehicle. Thus, in the present embodiment, when it is determined that the own vehicle turns right, a part of the own vehicle presence region EA1 on the right side with respect to the own vehicle traveling direction is increased to set the collision determination to the safe side.

A width change ΔW1 of the own vehicle presence region EA1 due to the change in the steering amount of the own vehicle is calculated by using a yaw rate ψ1 and a change acceleration α1 of the steering amount in the right direction of the own vehicle. In the present embodiment, the increase amount ΔS1 of the own vehicle presence region EA1 when the own vehicle turns right is calculated by the following equation (1).

$$\begin{matrix}[ Math . 1 ] & \\ Δ S {1}_{n} = k \cdot Δ W {1}_{n} = k \cdot ( φ 1 \cdot {T}_{n} + \frac{1}{2} \cdot α 1 \cdot {T}_{n}^{2} ) & ( 1 )\end{matrix}$$

ΔS1n represents the increase amount of the object at each elapsed time Tn when the own vehicle turns right. Furthermore, k represents the length of the own vehicle in the vehicle length direction.

In equation (1), the increase amount ΔS1 at the current time T0 is 0 because the elapsed time T0 is 0. The increase amount ΔS1 is increased as the elapsed time Tn corresponding to the reference position P of the own vehicle on the own vehicle estimated route PA1 is increased. In the embodiment, the collision determination ECU 20 stores table information regarding a relationship between the yaw rate ψ1, the acceleration α1 of the steering angle, the elapsed time T, and the increase amount ΔS1, and by referring to the table information, the collision determination ECU 20 sets the increase amount ΔS1 when the own vehicle turns right corresponding to the values ψ1, α1, and T.

For example, the table information is calculated as follows. First, various relationships of the yaw rate ψ1 and change acceleration α1 of the steering amount with the increase amount ΔS1 are calculated on the basis of equation (1). Then, the collision determination ECU 20 stores, as the table information, a correspondence relationship between the yaw rate ψ1, the acceleration α1 of the steering angle, the elapsed time T, and the increase amount ΔS1.

Returning to FIG. 6, in a case where it is determined at step S13 that the own vehicle turns left, at step S15, an increase amount ΔS2 of the own vehicle presence region EA1 when the own vehicle turns left is set on the basis of a yaw rate ψ2 and a change acceleration α2 of the steering amount of the own vehicle calculated at step S12.

When the own vehicle turns left, there is a possibility that an object that passes on the left side of the own vehicle is collide with the own vehicle. Thus, in the present embodiment, when it is determined that the own vehicle turns left, as shown in FIG. 7B, only a part of the own vehicle presence region EA1 on the left side with respect to the own vehicle traveling direction is increased to set the collision determination to the safe side.

An increase amount ΔS2 of the own vehicle presence region EA1 due to the change in the steering amount when the own vehicle turns left is calculated by the following equation (2) using the yaw rate ψ2 and the change acceleration α2 of the steering amount in the left direction of the own vehicle.

$$\begin{matrix}[ Math . 2 ] & \\ Δ S {2}_{n} = k \cdot Δ W {2}_{n} = k \cdot ( φ 2 \cdot {T}_{n} + \frac{1}{2} \cdot α 2 \cdot {T}_{n}^{2} ) & ( 2 )\end{matrix}$$

ΔS2n represents the increase amount of the object at each elapsed time Tn when the own vehicle turns left. ΔW2n is a width change of the own vehicle presence region EA1 when the own vehicle turns left.

In equation (2), the increase amount ΔS2 at the current time T0 on the own vehicle estimated route PA1 is 0. The increase amount ΔS2 is increased as the elapsed time T corresponding to each own vehicle presence region EA1 is increased. In the embodiment, the collision determination ECU 20 stores table information regarding a relationship between the yaw rate ψ2, the change acceleration α2 of the steering amount, the elapsed time T, and the increase amount ΔS2, and by referring to the table information, the collision determination ECU 20 sets the increase amount ΔS2 when the own vehicle turns left corresponding to the values ψ2, α2, and T.

At step S16, a plurality of own vehicle presence regions EA1 that pass through the own vehicle estimated route PA1 are calculated according to the increase amount set at step S14 or step S15. At step S17, the own vehicle solid D1 is calculated by interpolating, in the three-dimensional coordinate system, the plurality of own vehicle presence regions EA1 calculated at step S16.

At step S18, a plurality of object presence regions EA2 that pass through the object estimated route PA2 are calculated. At step S19, the object solid D2 is calculated by interpolating, in the three-dimensional coordinate system, the plurality of object presence regions EA2 calculated at step S18.

At step S20, it is determined whether the own vehicle solid D1 calculated at step S17 intersects the object solid D2 calculated at step S19. Specifically, when the overlapping region OA is present between the first determination region DA1 and the second determination region DA2 at the same elapsed time T, it is determined that the own vehicle solid D1 intersects the object solid D2.

When it is determined in the process at step S20 that the own vehicle solid D1 intersects the object solid D2, at step S21, it is determined that the object will collide with the own vehicle, and control proceeds to step S22. When it is determined that the own vehicle solid D1 does not intersect the object solid D2, this iteration of the process in FIG. 6 is ended.

In the present embodiment, on condition that it is determined that the own vehicle solid D1 intersects the object solid D2, at step S22, TTC at the current position of the own vehicle is calculated. TTC indicates time to collision which is time until the own vehicle will collide with the object. For example, TTC is calculated by dividing a straight-line distance from the current position of the own vehicle to the object by the relative speed of the object to the own vehicle.

At step S23, it is determined whether TTC calculated at step S22 is equal to or less than a threshold TH1. First, when it is determined that TTC exceeds the threshold TH1, the process in FIG. 6 is temporarily ended. When it is determined in the subsequent process at step S23 that TTC is equal to or less than the threshold TH1, control proceeds to step S24.

At step S24, collision prevention control for the own vehicle is performed. For example, a speed reduction signal is outputted to the brake ECU 31 to reduce the own vehicle speed. Step S24 corresponds to an operation control unit.

When the process at step S24 is ended, this iteration of the process in FIG. 6 is ended.

The present embodiment described above can achieve the following effects.

The collision determination ECU 20 calculates, in the three-dimensional coordinate system including the elapsed time from the current time, the own vehicle solid D1 which is a solid showing change of the own vehicle presence region EA1 and the object solid D2 which is a solid showing change of the object presence region EA2. Then, the collision determination ECU 20 determines whether the object will collide with the own vehicle on the basis of whether the own vehicle solid D1 intersects the object solid D2. In this case, the collision determination is performed by using the own vehicle solid D1 extending in the three-dimensional coordinate system. Thus, the intersection occurs in a larger region than in the case where the movement locus of the own vehicle intersects the movement locus of the object. This allows collision determination corresponding to various situations with various positional relationships of the object with respect to the own vehicle and movement states of the object, leading to appropriate determination of whether the object will collide with the own vehicle. Furthermore, it is determined whether a collision occurs on the basis of whether the own vehicle solid D1 intersects the object solid D2 in the three-dimensional coordinate system. Thus, the determination of whether a collision occurs can be appropriately performed in consideration of the elapse of time.

When an error occurs in the own vehicle estimated route PA1, as the position of the own vehicle presence region EA1 is located farther from the current position toward a future position on the own vehicle estimated route PA1, the error in the own vehicle estimated route PA1 is accumulated at the position of the own vehicle presence region EA1, resulting in an increase in the error in the position of the own vehicle presence region EA1. In this regard, in the above configuration, the collision determination ECU 20 calculates the own vehicle presence region EA1 so that the own vehicle presence region EA1 is increased as the own vehicle presence region EA1 is located farther from the current position toward a future position on the own vehicle estimated route PA1, and then calculates the own vehicle solid D1 by using the calculated own vehicle presence regions. In this case, the own vehicle solid D1 is calculated by taking into consideration the accumulation of the error in the own vehicle estimated route PA1; thus, the collision determination of whether the object will collide with the own vehicle can be set to the safe side.

As the change in the steering amount of the own vehicle is increased, the position of the own vehicle is more likely to be changed in the vehicle width direction. In this regard, in the above configuration, the collision determination ECU 20 sets the increase amount of the own vehicle presence region EA1 on the basis of the yaw rate ψ and the change acceleration α of the steering amount. In this case, the own vehicle presence region is increased by taking into consideration wandering of the own vehicle or a sudden change in the steering amount. Thus, for example, when the own vehicle turns right or left, the collision determination of whether the own vehicle will collide with an object that passes on the vicinity of the own vehicle can be set to the safe side.

### Modification of the First Embodiment

At steps S14 and S15, the increase amount ΔS may be set by using only the yaw rate ψ. In this case, the calculation of the change acceleration α of the steering amount at step S12 may be omitted.

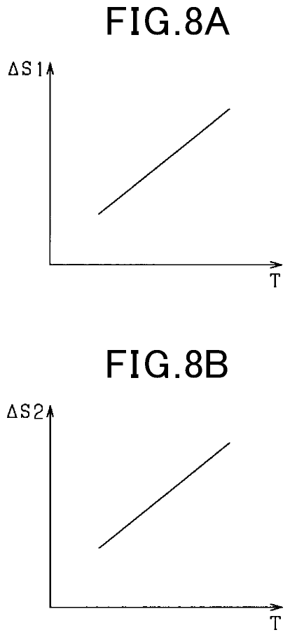

As shown in FIG. 8A, a value of the increase amount ΔS1 when the own vehicle turns right may be increased in proportion to an increase in the elapsed time T corresponding to each own vehicle presence region EA1. As shown in FIG. 8B, a value of the increase amount ΔS2 when the own vehicle turns left may be increased in proportion to an increase in the elapsed time T corresponding to each own vehicle presence region EA1.

### Second Embodiment

In the second embodiment, a configuration different from that of the first embodiment will be mainly described. In the second embodiment, the same portions as in the first embodiment are given the same reference numerals and are not repeatedly described.

Once the collision prevention control is performed for the own vehicle, the own vehicle is highly likely to collide with the object, and accordingly, it is not preferable to inadvertently end the collision prevention control. Thus, in the present embodiment, after the collision prevention control is performed for the own vehicle, the collision determination ECU 20 increases the increase amount ΔS of the own vehicle presence region EA1 so that the own vehicle solid D1 is more likely to intersect the object solid D2 in subsequent calculations.

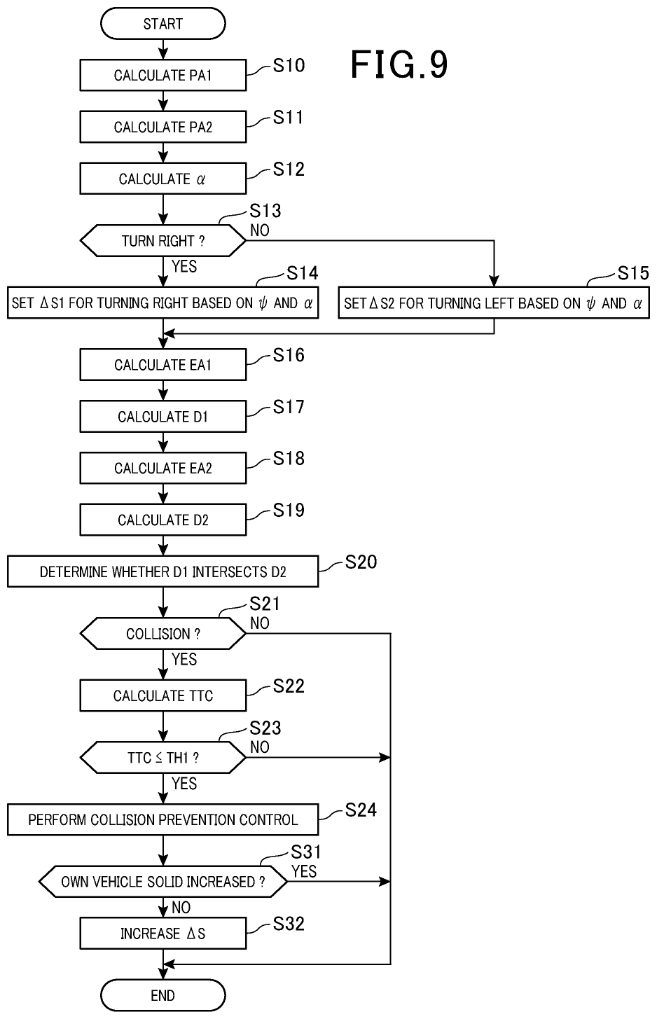

A procedure of the collision determination of whether the object will collide with the own vehicle according to the present embodiment will be described with reference to FIG. 9. A process shown in FIG. 9 is repeatedly performed in a predetermined cycle by the collision determination ECU 20.

When it is determined at step S21 that the object will collide with the own vehicle, control proceeds to step S22 and TTC is calculated. At step S23, it is determined whether TTC calculated at step S22 is equal to or less than the threshold TH1. When it is determined that TTC is equal to or less than the threshold TH1, control proceeds to step S24 and collision prevention control for the own vehicle is performed.

At step S31, it is determined whether the own vehicle solid D1 has been increased due to implementation of the collision prevention control. First, when it is determined that the own vehicle solid D1 has not been increased due to implementation of the collision prevention control, control proceeds to step S32.

At step S32, the increase amount ΔS of the own vehicle presence region EA1 at the same elapsed time T is increased as compared with the increase amount ΔS before the collision prevention control is performed. In the present embodiment, the increase amount ΔS1 set at step S14 and the increase amount ΔS2 set at step S15 in subsequent calculation cycles are set to be larger than the increase amount ΔS1 and the increase amount ΔS2 before the collision prevention control is performed, respectively. Thus, at step S16, the own vehicle presence region EA1 at the same elapsed time T is increased as compared with the own vehicle presence region EA1 before the collision prevention control is performed. Steps S16 and S32 correspond to an own vehicle region increasing unit. When the process at step S32 is ended, the process in FIG. 9 is temporarily ended.

In the present embodiment described above, after TTC becomes equal to or less than the threshold TH1 and thus the collision prevention control is performed for the own vehicle, the collision determination ECU 20 increases the own vehicle presence region EA1 used to calculate the own vehicle solid D1. Thus, in the determination at step S20 performed for each subsequent calculation cycle, the own vehicle solid D1 is more likely to intersect the object solid D2, and consequently, it is more likely to be determined that the object will collide with the own vehicle. This makes it possible to prevent the collision prevention control from being inadvertently ended after the collision prevention control is performed for the own vehicle.

### Modification of the Second Embodiment

After TTC becomes equal to or less than the threshold TH1 and thus the collision prevention control is performed for the own vehicle, the collision determination ECU 20 may increase the increase amount of the object presence region EA2, instead of increasing the increase amount of the own vehicle presence region EA1. In this case, at step S32, the increase amount of the object solid D2 at step S19 only needs to be set to a larger value than the increase amount of the object solid D2 before the collision prevention control is performed. Alternatively, at step S32, together with the increase in the increase amount of the own vehicle presence region EA1, the increase amount of the object presence region EA2 may be increased. In the present embodiment, steps S19 and S32 correspond to an object region increasing unit.

### Third Embodiment

In the third embodiment, a configuration different from that of the first embodiment will be mainly described. In the third embodiment, the same portions as in the first embodiment are given the same reference numerals and description thereof is not repeated.

As the position of the object presence region EA2 is located farther from the current position toward a future position on the object estimated route PA2, the error in the object estimated route PA2 is accumulated at the position of the object presence region EA2, resulting in an increase in the error in the position of the object presence region EA2. Thus, in the present embodiment, the collision determination ECU 20 calculates the object presence region EA2 so that the area of the object presence region EA2 is increased as the corresponding elapsed time T is increased from the current time toward a future time on the object estimated route PA2.

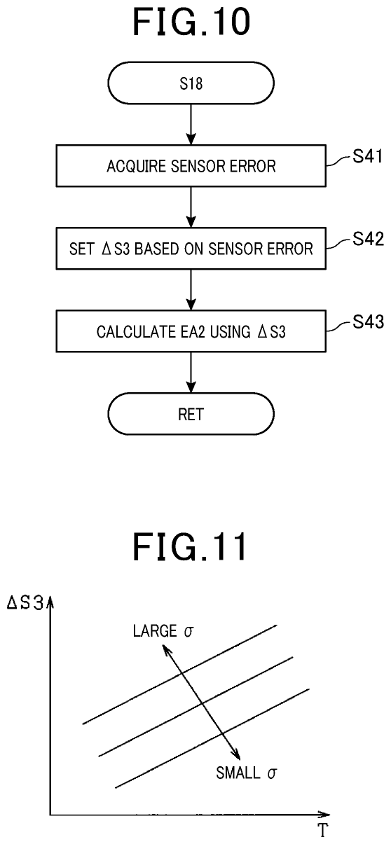

FIG. 10 shows a procedure of the process at step S18 in FIG. 6 of the present embodiment.

The object estimated route PA2 is calculated on the basis of the position of the object detected by the object detection device 10. Accordingly, an error in the position of the object estimated route PA2 is changed according to a sensor error σ that represents an error caused by the object detection device 10. Thus, at step S41, the sensor error σ caused by the object detection device 10 is acquired. In the present embodiment, the sensor error σ caused by the object detection device 10 is stored in advance in a memory such as a ROM.

At step S42, an increase amount ΔS3 of the object presence region EA2 is set on the basis of the sensor error σ acquired at step S41. In the present embodiment, as shown in FIG. 11, the increase amount ΔS3 is set to a larger value as the elapsed time T is increased from the current time toward a future time on the object estimated route PA2. Furthermore, the increase amount ΔS3 is set to a larger value as the sensor error σ is increased.

At step S43, the object presence region EA2 is calculated by using the increase amount ΔS3 set at step S42. Thus, the object presence region EA2 is calculated so that the area of the object presence region EA2 is increased as the object presence region EA2 is located farther from the current position toward a future position on the object estimated route PA2.

When the process at step S43 is ended, control proceeds to step S19 in FIG. 6.

The present embodiment described above can achieve the following effects.

The collision determination ECU 20 calculates the object presence region EA2 so that the area of the object presence region EA2 is increased as the object presence region EA2 is located farther from the current position toward a future position on the object estimated route PA2. In this case, the object presence region EA2 is calculated by taking into consideration the error in detection of the object estimated route PA2; thus, the collision determination of whether the object will collide with the own vehicle can be set to the safe side.

The collision determination ECU 20 sets the increase amount ΔS3 of the area of the object presence region EA2 on the basis of the error in detection by the object detection device 10. In this case, an unnecessary increase in the object presence region EA2 is prevented, and the collision determination of whether the object will collide with the own vehicle can be more appropriately performed.

### Fourth Embodiment

In the fourth embodiment, a configuration different from that of the first embodiment will be mainly described. In the fourth embodiment, the same portions as in the first embodiment are given the same reference numerals and are not repeatedly described.

The movement path of the object may be formed in a linear shape in the three-dimensional coordinate system, instead of being calculated as a solid in the three-dimensional coordinate system.

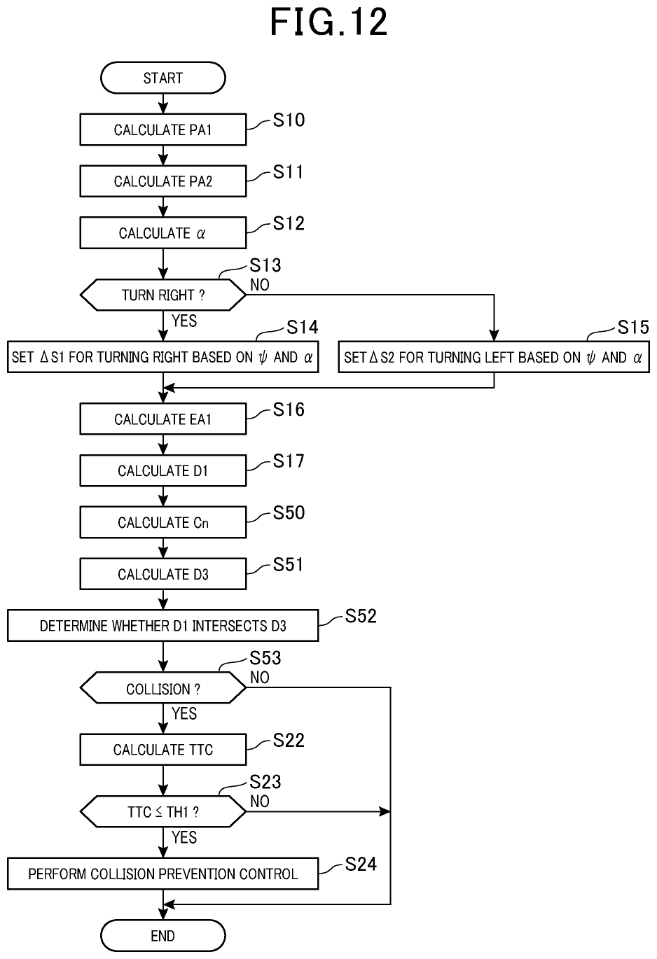

A procedure of the collision determination of whether the object will collide with the own vehicle according to the present embodiment will be described with reference to FIG. 12. A process shown in FIG. 12 is repeatedly performed in a predetermined cycle by the collision determination ECU 20.

At step S17, the own vehicle solid D1 is calculated, and control proceeds to step S50. At step S50, a plurality of positions Cn at different elapsed times T on the object estimated route PA2 are calculated. Thus, in the present embodiment, the object presence region EA2 is not calculated.

At step S51, an object movement path D3 in the three-dimensional coordinate system is calculated by interpolating, in the three-dimensional coordinate system, the plurality of positions Cn on the object estimated route PA2 calculated at step S50. Thus, in the present embodiment, the object solid D2 is not calculated.

At step S52, it is calculated whether the own vehicle solid D1 intersects the object movement path D3 calculated at step S51. Thus, in the present embodiment, when the own vehicle solid D1 intersects the object movement path D3, it is determined that the object will collide with the own vehicle.

When it is determined at step S52 that the own vehicle solid D1 intersects the object movement path D3, at step S53, it is determined that the object will collide with the own vehicle. Then, control proceeds to step S22 and TTC is calculated. On the other hand, when it is determined at step S52 that the own vehicle solid D1 does not intersect the object movement path D3, at step S53, it is determined that the object does not collide with the own vehicle, and the process in FIG. 12 is temporarily ended.

The present embodiment described above can achieve the same effects as the first embodiment.

### Other Embodiments

The determination of whether the own vehicle solid D1 intersects the object solid D2 at step S20 in FIGS. 6 and 9 may be performed as follows. First, an outer peripheral surface that forms the own vehicle solid D1 for a predetermined duration is calculated. Furthermore, sides of the object solid D2 for the same duration that extend in the T-axis direction are calculated. Then, when any of the sides calculated from the object solid D2 passes on the outer peripheral surface calculated from the own vehicle solid D1, it is determined that the own vehicle solid D1 intersects the object solid D2. Similarly, it may be determined that the own vehicle solid D1 intersects the object solid D2 when any of the sides calculated from the own vehicle solid D1 passes on the outer peripheral surface calculated from the object solid D2.

The determination of whether the own vehicle solid D1 intersects the object solid D2 at step S20 in FIGS. 6 and 9 may be performed as follows. First, the own vehicle solid D1 for a predetermined duration is converted into a solid composed of a polygon. Furthermore, sides of the object solid D2 for the predetermined duration that extend in the T-axis direction indicating the elapsed time are calculated. Then, when any of the sides calculated from the object solid D2 passes on the outer peripheral surface composed of the polygon of the converted own vehicle solid D1, it is determined that the own vehicle solid D1 intersects the object solid D2. Similarly, the object solid D2 is converted into a solid composed of a polygon. Then, when any of the sides calculated from the own vehicle solid D1 passes on the outer peripheral surface composed of the polygon of the converted object solid D2, it is determined that the own vehicle solid D1 intersects the object solid D2.

The shapes of the own vehicle presence region EA1 and the object presence region EA2 may be a shape other than the rectangular shape. For example, when the collision determination ECU 20 can determine a type of the object detected by the object detection device 10, the shape of the object presence region EA2 may be changed according to the determined object type. The object type determined by the collision determination ECU 20 may be a four-wheel vehicle, a two-wheel vehicle, a pedestrian, an animal, a structure, and the like.

The area S of the own vehicle presence region EA1 used to calculate the own vehicle solid D1 may not necessarily be increased with the elapsed time T. In this case, in the calculation of the own vehicle presence region EA1 at step S16 in FIGS. 6, 9, and 12, the area S may be constant regardless of the elapsed time T. Accordingly, the processes at steps S12 to S15 in FIGS. 6, 9, and 12 are omitted.

The object detection device 10 may be a device including an image sensor that detects a position of an object by using a captured image and a laser sensor that detects a position of an object by using laser light, instead of the device composed of the millimeter wave radar sensor 11 and the radar ECU 12. Alternatively, when the own vehicle can perform inter-vehicle communication with another vehicle traveling around the own vehicle, the own vehicle may acquire, by inter-vehicle communication, a position of an object detected by an object detection device of the vehicle traveling around the own vehicle.

The collision determination ECU 20 may calculate the own vehicle estimated route PA1 by using an acceleration of the own vehicle, in addition to the yaw rate ψ of the own vehicle and the own vehicle speed.

The collision determination ECU 20 shown in FIG. 1 may not necessarily include the own vehicle region calculation unit 22. In this case, for example, the collision determination ECU 20 may be configured such that information on the own vehicle presence region is stored in a storage device of the collision determination ECU 20 and information on the own vehicle presence region read from the storage device as appropriate is used by the own vehicle information calculation unit 23. Specifically, for example, the collision determination ECU 20 may be configured such that information on the own vehicle presence region for each predetermined time related to the own vehicle estimated route PA1 is stored in the storage device and on the basis of the own vehicle estimated route PA1 calculated by the own vehicle route estimation unit 21, information on the own vehicle presence region corresponding to the route PA1 is read from the storage device and then the read information on the own vehicle presence region for each predetermined time is used by the own vehicle information calculation unit 23.

The present disclosure has been described in accordance with the embodiments, but it is understood that the present disclosure is not limited to the embodiments or structures. The present disclosure encompasses various modifications and variations in an equivalent range. In addition, the scope and spirit of the present disclosure encompass various combinations or forms and other combinations or forms including only one element, one or more elements, or one or less elements.

What is claimed is:

1. A collision determination device that determines whether an own vehicle will collide with an object that is located around the own vehicle and detected by an object detection device, the collision determination device comprising:
an own vehicle region calculation unit that calculates an own vehicle presence region for each predetermined time on an estimated route of the own vehicle in a two-dimensional coordinate system defined by a distance in an own vehicle traveling direction and a distance in a vehicle width direction of the own vehicle at a current time;
an own vehicle information calculation unit that calculates an own vehicle solid by interpolating the calculated own vehicle presence region for each predetermined time in a three-dimensional coordinate system defined by the distance in the own vehicle traveling direction, the distance in the vehicle width direction, and elapsed time from the current time, the own vehicle solid being a solid showing change of the own vehicle presence region;
a movement path calculation unit that calculates a movement path of the object in the three-dimensional coordinate system on the basis of a position of the object detected by the object detection device; and
a determination unit that determines whether the object will collide with the own vehicle on the basis of whether the calculated own vehicle solid intersects the calculated movement path of the object.

2. The collision determination device according to claim 1, wherein
the own vehicle region calculation unit calculates the own vehicle presence region so that an area of the own vehicle presence region is increased as the own vehicle presence region is located farther from a current position toward a future position on the estimated route of the own vehicle.

3. The collision determination device according to claim 2, further comprising:
a change amount calculation unit that calculates at least one of a change rate of a steering amount of the own vehicle and a change acceleration of the steering amount, wherein
the own vehicle region calculation unit sets an increase amount of the area of the own vehicle presence region on the basis of at least one of the change rate of the steering amount and the change acceleration of the steering amount calculated by the change amount calculation unit.

4. The collision determination device according to claim 1, wherein:
the movement path calculation unit calculates an object presence region for each predetermined time on an estimated route of the object based on the position of the object in the two-dimensional coordinate system; and
the movement path calculation unit calculates, as the movement path of the object, a solid showing change of the object presence region by interpolating the calculated object presence region for each predetermined time in the three-dimensional coordinate system.

5. The collision determination device according to claim 4, wherein
the movement path calculation unit calculates the object presence region so that an area of the object presence region is increased as the object presence region is located farther from a current position toward a future position on the estimated route of the object.

6. The collision determination device according to claim 5, wherein
the movement path calculation unit sets an increase amount of the area of the object presence region on the basis of an error in detection by the object detection device.

7. The collision determination device according to claim 1, further comprising:
an operation control unit that performs collision prevention control for preventing the own vehicle from colliding with the object in response to the calculated own vehicle solid intersecting the calculated movement path of the object; and
an own vehicle region increasing unit that after the collision prevention control for the own vehicle is performed, increases the own vehicle presence region used to calculate the own vehicle solid as compared with the own vehicle presence region before the collision prevention control is performed.

8. The collision determination device according to claim 4, further comprising:
an operation control unit that performs collision prevention control for preventing the own vehicle from colliding with the object in response to the calculated own vehicle solid intersecting the calculated movement path of the object; and
an object region increasing unit that after the collision prevention control for the own vehicle is performed, increases the object presence region used to calculate the movement path of the object as compared with the object presence region before the collision prevention control is performed.

9. A collision determination device that determines whether an own vehicle will collide with an object that is located around the own vehicle and detected by an object detection device, the collision determination device comprising:
an own vehicle information calculation unit that determines, as an own vehicle presence region, a region in which the own vehicle is present for each predetermined time on an estimated route of the own vehicle in a two-dimensional coordinate system defined by a distance in an own vehicle traveling direction and a distance in a vehicle width direction of the own vehicle at a current time and that calculates an own vehicle solid by interpolating the own vehicle presence region for each predetermined time in a three-dimensional coordinate system defined by the distance in the own vehicle traveling direction, the distance in the vehicle width direction, and elapsed time from the current time, the own vehicle solid being a solid showing change of the own vehicle presence region;
a movement path calculation unit that calculates a movement path of the object in the three-dimensional coordinate system on the basis of a position of the object detected by the object detection device; and
a determination unit that determines whether the object will collide with the own vehicle on the basis of whether the calculated own vehicle solid intersects the calculated movement path of the object.
